(19) United States
(12) Patent Application Publication
(10) Pub. No.: US 2025/0287951 A1
(43) Pub. Date: Sep. 18, 2025

(54) NO BITE NO SCENT LOTION

(71) Applicant: Pouch Pac Innovations, LLC, Sarasota, FL (US)

(72) Inventors: R. Charles Murray, Sarasota, FL (US); John Harlin, Sarasota, FL (US)

(21) Appl. No.: 19/077,214

(22) Filed: Mar. 12, 2025

Related U.S. Application Data
(60) Provisional application No. 63/564,685, filed on Mar. 13, 2024.

(51) Int. Cl. A01N 49/00; A01N 25/04; A01N 65/22; A01P 17/00

(52) U.S. Cl. CPC A01N 49/00; A01N 25/04; A01N 65/22; A01P 17/00

(57) ABSTRACT

A topical insect repellant composition is disclosed. The topical insect repellent composition includes active ingredients and inert ingredients. The active ingredients include geraniol and rosemary oil. The inert ingredients include white mineral oil, oleic acid (CH3(CH2)7CH═CH(CH2)7COOH), isopropyl myristate, isopropyl alcohol, lauric acid (CH3(CH2)10COOH), monolaurin (H3C(CH2)10COOCH2CH(OH)CH2OH), triethyl citrate, and vanillin. The composition has no scent.

### CROSS-REFERENCE TO RELATED APPLICATIONS

This application claims priority to U.S. Prov. Pat. App. No. 63/564,685 filed on Mar. 13, 2024, the contents of which are hereby incorporated by reference in its entirety.

### TECHNICAL FIELD

The present disclosure is directed to a topical insect repellant formulation. More particularly, the present disclosure is directed towards a non-toxic, no scent insect repellant formulation that contains plant-based active ingredients. The topical insect repellant formulation may be in the form of a scent-free lotion.

### BACKGROUND

Mosquitoes and other biting insects cause annoying reactions in humans and animals. Additionally, mosquito bites are a vector for many types of disease including: malaria, Dengue Fever, Chikungunya, West Nile and Zika viruses as well as other forms of disease.

Various repellant compositions have been utilized in prior art repellant compositions. One such repellant, DEET, is often used in mosquito repellant compositions. DEET has been questioned as to its toxicity in higher amounts for use with humans and other subjects. There is therefore a need in the art for an improved and safe topical mosquito repellant composition.

There is a need to prevent mosquitos from biting a host to lessen the discomfort of a bite reaction and to prevent the potential spread of a disease.

Further, there is a need for a natural, topical formulation that is scent free to humans (no scent).

Accordingly, a natural non-toxic ingredient based topical product that prevents bites to humans and animals and is scent-free would be desirable.

Pursuant to the disclosure, there is provided a natural non-toxic ingredient, plant-based composition that is scent-free to repel biting insects, as set forth in the appended claims.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

An object of the disclosure is to provide a safe, non-toxic and scent-free topical mosquito formulation.

In one aspect, there is disclosed a topical mosquito repellant composition including active and inert ingredients. The active ingredients are non-toxic and plant based, and include geraniol and rosemary oil. The inert ingredients include white mineral oil, oleic acid (CH3(CH2)7CH═CH(CH2)7COOH), isopropyl myristate, isopropyl alcohol, lauric acid (CH3(CH2)10COOH), monolaurin (H3C(CH2)10COOCH2CH(OH)CH2OH), triethyl citrate, and vanillin.

The topical mosquito repellant composition has no scent. The topical mosquito repellant composition may be in the form of a lotion.

In another aspect, there is disclosed a topical insect repellant composition including a lotion with active ingredients and inert ingredients. The active ingredients include geraniol and rosemary oil. The inert ingredients include white mineral oil, oleic acid (CH3(CH2)7CH═CH(CH2)7COOH), isopropyl myristate, isopropyl alcohol, lauric acid (CH3(CH2)10COOH), monolaurin (H3C(CH2)10COOCH2CH(OH)CH2OH), triethyl citrate, and vanillin. The lotion has no scent.

In another aspect, there is disclosed a method of repelling insects including applying a topical insect repellant composition to a body, the topical insect repellant composition including active ingredients and inert ingredients. The active ingredients include geraniol and rosemary oil. The inert ingredients include white mineral oil, oleic acid (CH3(CH2)7CH═CH(CH2)7COOH), isopropyl myristate, isopropyl alcohol, lauric acid (CH3(CH2)10COOH), monolaurin (H3C(CH2)10COOCH2CH(OH)CH2OH), triethyl citrate, and vanillin. The topical insect repellant composition (e.g., a lotion) has no scent.

Additional features and advantages of the no scent no bite insect repellant formulation described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter.

### DETAILED DESCRIPTION

In one aspect, there is disclosed herein an insect repellant formulation formed from plant-based active ingredients. The insect repellent formulation may be used as a topical product, e.g., a lotion.

### Example 1

In one aspect, the insect repellent formulation may include:

| | | | PERCENT |
|---|---|---|---|
| | PERCENTAGE | CAS | RANGE |
| ACTIVE | | | |
| INGREDIENTS | | | |
| Geraniol | 0.3 | 106-24-1 | PLUS- |
| | | | MINUS |
| | | | 50% |
| Rosemary Oil | 0.1 | 8000-25-7 | PLUS- |
| | | | MINUS |
| | | | 50% |
| INERT | | | |
| INGREDIENTS | | | |
| White Mineral | 59 | 8042-47-5 | PLUS- |
| Oil | | | MINUS |
| | | | 10% |
| Oleic Acid | 11.4 | 112-80-1 | PLUS- |
| | | | MINUS |
| | | | 10% |
| Isopropyl | 4 | 67-63-0 | PLUS- |
| Alcohol | | | MINUS |
| | | | 10% |
| Isopropyl | 21.5 | 110-27-0 | PLUS- |
| Myristate | | | MINUS |
| | | | 30% |
| Lauric Acid | 1 | 143-07-7 | PLUS- |
| | | | MINUS |
| | | | 30% |
| 1 Monolaurin | 1 | 142-18-7 | PLUS- |
| | | | MINUS |
| | | | 30% |
| Triethyl Citrate | 1.5 | 77-93-0 | PLUS- |
| | | | MINUS |
| | | | 30% |
| Vanillin | 0.25 | 121-33-5 | PLUS- |
| | | | MINUS |
| | | | 30% |

CP=5.76 ±10%, and/or the NTU=0.0, and/or density=0.871.

As specified above, the topical insect repellent composition or formulation includes active ingredients and inert ingredients. The active ingredients are plant-based and non-toxic, and include geraniol and rosemary oil. The inert ingredients may include white mineral oil, oleic acid (CH3(CH2)7CH═CH(CH2)7COOH), isopropyl myristate, isopropyl alcohol, lauric acid (CH3(CH2)10COOH), monolaurin (H3C(CH2)10COOCH2CH(OH)CH2OH), triethyl citrate, and vanillin. The insect repellant composition has no scent (scent-free).

The geraniol may be present in an amount of from 0.15% to 0.45% by weight (i.e., 0.3%±50%). The rosemary oil may be present in an amount of 0.05% to 0.15% by weight (i.e., 0.1%±50%). The white mineral oil may be present in an amount of from 53% to 65% by weight (i.e., 59%±10%). The oleic acid may be present in an amount of from 10.2% to 12.6% (i.e., 11.4%±10%). The isopropyl alcohol may be present in an amount from 3.5% to 4.5% by weight (i.e., 4%±10%). The isopropyl myristate may be present in an amount of from 15% to 28% by weight (i.e., 21.5%±30%). The lauric acid may be present in an amount from 0.7% to 1.3% by weight (i.e., 1%±30%). The monolaurin may be present in an amount from 0.7% to 1.3% by weight (i.e., 1%±30%). The triethyl citrate may be present in an amount from 1% to 2% by weight (i.e., 1.5%±30%). The vanillin may be present in an amount from 0.175% to 0.325% by weight (i.e., 0.25%±30%). The weight percentages are based on a total weight of the composition.

Geraniol and rosemary oil are both natural ingredients that synergistically work together to repel biting insects such as mosquitoes, ticks and flies. Geraniol, which comes from plants like roses and lemongrass, is a strong repellant that is very effective at keeping away mosquitoes, ticks, and other bugs. Geraniol is gentle on the skin and much less likely to irritate the skin compared to synthetic repellents like DEET. Additionally, geraniol has antibacterial effects, which can help protect minor cuts or bites from infection. Rosemary oil has further insect-repelling characteristics and is anti-inflammatory to help reduce redness and itching as well as exhibits antioxidant benefits that help protect the skin from damage. Rosemary oil together with geraniol as active ingredients provides more robust protection against biting insects by increasing the repelling power in synergistic manner as well as helps soothe the skin. Rosemary oil and geraniol are non-toxic, plant-based ingredients. Further, the disclosed concentration ranges of active ingredients, e.g., geraniol of 0.15% to 0.45% by weight (i.e., 0.3%±50%) and rosemary oil of 0.05% to 0.15% by weight (i.e., 0.1%±50%), helps ensure a scent free formulation when combined with the specified portions of inert ingredients and absent other active ingredients.

The proportion of white mineral oil acts as a carrier medium for the active ingredients without reacting chemically, and enhances skin softness and smoothness when applied as a topical product. The proportion of oleic acid serves as an emollient and may aid in emulsifying the oil phase of the formulation. The proportion of isopropyl myristate improves spreadability and texture of the formulation, and contributes to a non-greasy feel when the topical product is spread on the skin. The proportion of isopropyl alcohol helps dissolve other ingredients to facilitate a homogenous mixture, and accelerates drying time upon application. The proportion of lauric acid acts as an emollient and provides antimicrobial properties. The proportion of monolaurin enhances antimicrobial properties and has a synergistic effect with lauric acid that enhances the breadth and effectiveness of antimicrobial action. The proportion of triethyl citrate helps maintain the formulation's stability and viscosity, and acts as a pH regulator to enhance the compatibility of the other ingredients. The proportion of vanillin acts as a scent-masking agent and may provide antioxidant properties to minimize degradation.

Pursuant to an implementation, the active ingredients consists of geraniol and rosemary oil in the above-specified proportions. Additionally or alternatively, the inert ingredients consists of white mineral oil, oleic acid, isopropyl alcohol, isopropyl myristate, lauric acid, monolaurin, triethyl citrate, and vanillin, in the above-specified proportions.

Notably, the insect repellant formula does not contain decanoic acid, which is not allowed in FIFRA Section 25(b) pesticides.

In one aspect, the composition(s) described above has no appreciable essential oil odor as sensed by the human nose. In other words, the composition may be considered scent free. A scent free insect repellant may have various advantages over current repellents. For example, please with sensitivity to strong scents may prefer such a composition. People who wish to remain undetected by their scent may prefer such a composition. People around animals may prefer such a composition to lessen a reaction by an animal to the insect repellent.

Pursuant to an example, the composition may be made according to the following procedure. The mineral oil is heated to a temperature of about 145 to 160 degrees F. in a mixing vat under agitation. Next, the oleic acid, monolaurin, and triethyl citrate are added with a temperature controlled to 145 to 150 degrees F., and, while the temperature is maintained at 145 to 150 degrees F., then the isopropyl myristate, vanillin, and lauric acid are added while under agitation. The isopropyl myristate, vanillin, and lauric acid may be added sequentially (in separate steps), or together collectively with or without the oleic acid. Next, the isopropyl alcohol is added once the temperature cools to 110 to 125 degrees F. The composition is maintained under agitation. At this time, a shearing mechanism is activated and maintained until the mixture contains no grit. Next, the geraniol and rosemary oil are added and a shear mechanism is activated and the composition cools to about 110 degrees F. The composition is agitated and sheared for a specified time dependent upon the size of the batch until the composition contains no grit. After which time the lotion may be packaged into a tube or bottle, among other containers.

### Testing and Results

The deterrent effect of the above-described composition of Example 1 was tested in a controlled environment. In vitro laboratory tests were conducted and measured and compared to DEET and nontreated control groups for yellow fever mosquitos, Aedes aegypti. Bioassays were conducted in nine six-chambered Plexiglas K & D modules stocked with female Aedes aegypti mosquitos. Five female mosquitos were aspirated into each of the six chambers of the nine modules. Repellant treatments were applied at 26.7 microliters with a pipette and spread with a small brush over 12 square centimeter sections of organdy cloth attached to a flat plastic template containing rectangular openings. The treated cloth covered template was fitted between the K & D module and a lower Plexiglas unit. The lower Plexiglas unit contained shallow surface wells filled with a blood substitute (CDTA and ATP) and covered with a moistened collagen membrane. The blood substitute was heated to 38° C. using water pumped through hose lines attached to the lower units and a water bath supplied with a temperature controlled inversion circulator. Mosquitos were exposed to the treated surfaces by opening sliding doors beneath the modules for 90-second biting counts at five post-treatment time intervals from 1 to 8 hours. Fresh, untreated mosquitos are used for each time interval.

The bite counts were tabulated and utilized for statistical analysis. The percent repellency of the formulations as described above was more effective than DEET over the five time periods. As measured by percent repellency, the compositions of Example 1 performed better than the Cutter Skinsations 7% DEET at all time intervals. The synergistic effect of geraniol and rosemary oil increased potency/efficacy for a robust repellant and the combination of inert ingredients help increase repellency duration and shelf life of the product.

Repellency for the composition of Example 1 ranged from 95-85% at 0-8 hrs. post-treatment, with 95% repellency at 0 hrs and 85% at 8hrs. The greatest repellency for Cutter Skinsations was 87% at 1 hr. post-treatment. Repellency was slightly lower through 4 hrs. and then dropped to 48% and 39%, respectively, at 6 and 8 hrs. post-treatment for the DEET product. The compositions of Example 1 maintained 85% repellency for greater than 8 hours unlike the DEET product.

The average for all five time periods demonstrates the repellency of 87% for the composition of Example 1 as described herein compared to 62% for DEET.

The experimental results demonstrate a very high effectiveness of repellency utilizing a safe and effective organic product that is both DEET and chemical free. The testing has demonstrated that the product is effective in repelling mosquitos and in particular the yellow fever mosquito which may potentially carry West Nile virus.

### Additional Testing

### Sarasota, Florida.

The composition of Example 1 was applied to 10 people in a swamp-type environment in central Sarasota, Fla. The tests indicate 100% effectiveness in a natural environmental setting with high mosquito infestation. After application of the lotion of examples 1-2 as presented in the embodiments disclosed above, it was observed that the repellency is 100% and with no application of the product the number of bites normally exceeds 10 in a 5 minute exposure.

Additionally, the 10 people reported no appreciable essential oil odor of the product after it was applied to their bodies.

Even though the present disclosure has been described in detail with reference to specific examples, it will be appreciated that the various modifications and changes can be made to these examples without departing from the scope of the present disclosure as set forth in the claims. It is anticipated and intended that future developments will occur in the technologies discussed herein, and that the disclosed article and/or assembly will be incorporated into such future developments. Thus, the specification and the drawings are to be regarded as an illustrative thought instead of merely restrictive thought.

It should be understood that references to mosquito is meant to encompass all insects, e.g., mosquito repellent encompasses protection from biting insects including ticks, flies, gnats, and sand fleas, to name a few.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Further, all numbers expressing dimensions, ratios and the like, used in the specification and claims, are to be understood to encompass tolerances and other deviations as represented by the term “about” or “approximately.” For example, about 0.3% encompasses a tolerance range of 0.29%-0.31%; about 0.1% encompasses a tolerance range of 0.09%-0.11%.

The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are inclusive unless such a construction would be illogical.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary. Further, the use of “at least one of” is intended to be inclusive, analogous to the term and/or. As an example, the phrase “at least one of A, B and C” includes A only, B only, C only, or any combination thereof (e.g. AB, AC, BC or ABC). Additionally, use of adjectives such as first, second, etc. should be read to be interchangeable unless a claim recites an explicit limitation to the contrary. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. A topical insect repellant composition, comprising:
active ingredients including geraniol and rosemary oil; and
inert ingredients including white mineral oil oleic acid (CH3(CH2)7CH═CH(CH2)7COOH), isopropyl myristate, isopropyl alcohol, lauric acid (CH3(CH2)10COOH), monolaurin (H3C(CH2)10COOCH2CH(OH)CH2OH), triethyl citrate, and vanillin;
wherein the topical mosquito repellant composition has no scent.

2. The topical insect repellant composition of claim 1, wherein the geraniol is present in an amount of from 0.15% to 0.45% by weight and the rosemary oil is present in an amount of 0.05% to 0.15% by weight.

3. The topical insect repellant composition of claim 2, wherein the amount of the geraniol is about 0.3% by weight and the amount of the rosemary oil is about 0.1% by weight.

4. The topical insect repellant composition of claim 1, wherein the white mineral oil is present in an amount of from 53% to 65% by weight, the oleic acid is present in an amount of from 10.2% to 12.6% by weight, and the isopropyl alcohol is present in an amount from 3.5% to 4.5% by weight.

5. The topical insect repellant composition of claim 4, wherein the amount of the white mineral oil is about 59% by weight, the amount of the oleic acid is about 11.4% by weight, and the amount of the isopropyl alcohol is about 4% by weight.

6. The topical insect repellant composition of claim 1, wherein the isopropyl myristate is present in an amount of from 15% to 28% by weight, the lauric acid is present in an amount of from 0.7% to 1.3% by weight, the monolaurin is present in an amount of from 0.7% to 1.3% by weight, the triethyl citrate is present in an amount of from 1% to 2% by weight, and the vanillin is present in an amount from 0.175% to 0.325% by weight.

7. The topical insect repellent composition of claim 6, wherein the amount of the isopropyl myristate is about 21.5% by weight, the amount of the lauric acid is about 1% by weight, the amount of the monolaurin is about 1% by weight, the amount of the triethyl citrate is about 1.5% by weight, and the amount of the vanillin is about 0.25% by weight.

8. The topical insect repellant composition of claim 1, in the form of lotion.

9. A topical insect repellant formulation, comprising:
a lotion including active ingredients and inert ingredients;
the active ingredients including geraniol and rosemary oil, wherein the geraniol is present in an amount of from 0.15% to 0.45% by weight and/or the rosemary oil is present in an amount of 0.05% to 0.15% by weight;
the inert ingredients including white mineral oil, oleic acid (CH3(CH2)7CH═CH(CH2)7COOH), isopropyl myristate, isopropyl alcohol, lauric acid (CH3(CH2)10COOH), monolaurin (H3C(CH2)10COOCH2CH(OH)CH2OH), triethyl citrate, and vanillin;
wherein the lotion has no scent.

10. The topical insect repellent formulation of claim 9, wherein the white mineral oil is present in an amount of from 53% to 65% by weight, the oleic acid is present in an amount of from 10.2% to 12.6% by weight, and the isopropyl alcohol is present in an amount from 3.5% to 4.5% by weight, the isopropyl myristate is present in an amount of from 15% to 28% by weight, the lauric acid is present in an amount of from 0.7% to 1.3% by weight, the monolaurin is present in an amount of from 0.7% to 1.3% by weight, the triethyl citrate is present in an amount of from 1% to 2% by weight, and the vanillin is present in an amount from 0.175% to 0.325% by weight.

11. A method of repelling insects, comprising:
applying a topical insect repellant composition to a body, the topical insect repellant composition including active ingredients and inert ingredients;
the active ingredients including geraniol and rosemary oil; and
the inert ingredients including white mineral oil, oleic acid (CH3(CH2)7CH═CH(CH2)7COOH), isopropyl myristate, isopropyl alcohol, lauric acid (CH3(CH2)10COOH), monolaurin (H3C(CH2)10COOCH2CH(OH)CH2OH), triethyl citrate, and vanillin;
wherein the topical insect repellant composition has no scent.

12. The method of claim 11, wherein the topical insect repellent composition is a lotion.

13. The method of claim 11, wherein the geraniol is present in an amount of from 0.15% to 0.45% by weight and the rosemary oil is present in an amount of 0.05% to 0.15% by weight.

14. The method of claim 11, wherein the white mineral oil is present in an amount of from 53% to 65% by weight, the oleic acid is present in an amount of from 10.2% to 12.6% by weight, and the isopropyl alcohol is present in an amount from 3.5% to 4.5% by weight.

15. The method of claim 11, wherein the isopropyl myristate is present in an amount of from 15% to 28% by weight, the lauric acid is present in an amount of from 0.7% to 1.3% by weight, the monolaurin is present in an amount of from 0.7% to 1.3% by weight, the triethyl citrate is present in an amount of from 1% to 2% by weight, and the vanillin is present in an amount from 0.175% to 0.325% by weight.
